(19) United States
(12) Patent Application Publication
(10) Pub. No.: US 2002/0181026 A1
(43) Pub. Date: Dec. 5, 2002

(54) Data transmission apparatus, data transmission method, data transmission program, and computer readable storage medium stored with data transmission program

(76) Inventor: Takenori Idehara, Yokohama-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/156,836

(22) Filed: May 30, 2002

(30) Foreign Application Priority Data
May 31, 2001 (JP) 2001-165293

(51) Int. Cl. H04N 1/00

(52) U.S. Cl. 358/402

(57) ABSTRACT

A data transmission apparatus includes an address book means on which an e-mail address, a file transfer server address and a facsimile number can be registered as an address for a destination, a setting means for setting one mode from a plurality of modes available for selecting an address applicable to a destination, when a plurality of destinations registered in the address book means are assigned as multicasting destinations, a selection means for selecting an address suitable for each destination according to the set mode, and a transmission means for executing multicasting transmission using a transmission protocol corresponding to the selected address for each destination.

This application is based on Japanese Patent Application No. 2001-165293 filed on May 31, 2001, the contents of which are hereby incorporated by reference.

### BACKGROUND OF THE INVENTION

1. Field of the Invention

The present invention is related to a data transmission apparatus, a data transmission method, a data transmission program, and a computer readable storage medium recorded with data transmission program.

2. Description of the Related Art

Various facsimile apparatuses have been proposed in recent years, which are capable of multicasting transmission of document image data via public telephone networks and the Internet.

For example, Japanese Unexamined Patent Application Publication HEI11-205573 disclosed a facsimile apparatus in which image data can be transmitted to a destination capable of receiving both facsimile and electronic mail (“e-mail”) by automatically selecting one of two communication methods.

However, there is a problem that the file size of an e-mail message is generally restricted by the capacity of a mailbox assigned to the destination user. For example, the user may not be able to receive an e-mail message attached with image data because image data is generally too large.

Moreover, when a mail server receives a plurality of broadcast e-mail messages, the server ends up storing the identical e-mail messages. It results in an inefficient use of its memory device.

On the other hand, it is also proposed to add to a facsimile apparatus a function for transmitting image data to a file transfer server. Since a file transfer server generally has little restrictions on file sizes, and is designed to store files that are shared by more than one user, the above-mentioned problem can be avoided.

However, the technology according to the Japanese Unexamined Patent Application Publication is not applicable to destinations that are capable of receiving information by means of file transfer as well as facsimile transmission and e-mail.

### SUMMARY OF THE INVENTION

It is therefore a general object of the invention to efficiently execute multicasting transmission to a plurality of destinations, for which e-mail addresses, file transfer server addresses, and facsimile numbers can be registered as their addresses.

More specifically, it is an object of the invention to provide a data transmission apparatus including an address book means on which an e-mail address, a file transfer server address and a facsimile number can be registered as an address for a destination, a setting means for setting one mode from a plurality of modes available for selecting an address applicable to a destination, when a plurality of destinations registered in the address book means are assigned as multicasting destinations, a selection means for selecting an address suitable for each destination according to the set mode, and a transmission means for executing multicasting transmission using a transmission protocol corresponding to the selected address for each destination.

Another object of the invention is to provide a data transmission method including the steps of setting one mode from a plurality of modes available for selecting an address applicable to a destination, which is registered on an address book means on which an e-mail address, a file transfer server address and a facsimile number can be registered as an address for the destination, when a plurality of the destinations are assigned as multicasting destinations, selecting an address suitable for each destination according to the set mode, and executing multicasting transmission using a transmission protocol corresponding to the selected address for each destination.

A further object of the invention is to provide a data transmission program for causing a computer to execute process of the steps of setting one mode from a plurality of modes available for selecting an address applicable to a destination, which is registered on an address book means on which an e-mail address, a file transfer server address and a facsimile number can be registered as an address for the destination, when a plurality of the destinations are assigned as multicasting destinations, selecting an address suitable for each destination according to the set mode, and executing multicasting transmission using a transmission protocol corresponding to the selected address for each destination.

Still a further object of the invention is to provide a computer readable storage medium stored with the above data transmission program.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram of a data transmission apparatus according to an embodiment of the present invention.

FIG. 2 is a table of assistance in explaining an address book concerning the data transmission apparatus.

FIG. 3 is a table of assistance in explaining a destination list concerning the data transmission apparatus.

FIG. 4 is a table of assistance in explaining a transmission list concerning the data transmission apparatus.

FIG. 5 illustrates an example of transmission mode selection screen on a display unit of the data transmission apparatus.

FIG. 6 is a flowchart of operations of the data transmission apparatus.

FIG. 7 is a flowchart of the transmission list preparation processing shown in FIG. 6.

FIG. 8 is a flowchart of the applicable list preparation processing shown in FIG. 7.

FIG. 9 is a table of assistance in explaining an e-mail applicable list concerning e-mail processing shown in FIG. 8.

FIG. 10 is a table of assistance in explaining an FTP applicable list concerning FTP processing shown in FIG. 8.

FIG. 11 is a table of assistance in explaining a facsimile applicable list concerning facsimile processing shown in FIG. 8.

FIG. 12 is a flowchart of the e-mail processing.

FIG. 13 is a flowchart of the FTP processing.

FIG. 14 is a flowchart of the FAX processing.

FIG. 15 is a flowchart of first mode processing shown in FIG. 7.

FIG. 16 is a flowchart of the first mode transmission list preparation processing shown in FIG. 15.

FIG. 17 is a flowchart of the time priority processing 1 shown in FIG. 16.

FIG. 18 is a flowchart of the time priority processing 2 shown in FIG. 16.

FIG. 19 is a flowchart of the time priority processing 3 shown in FIG. 16.

FIG. 20 is a flowchart of the time priority processing 4 shown in FIG. 16.

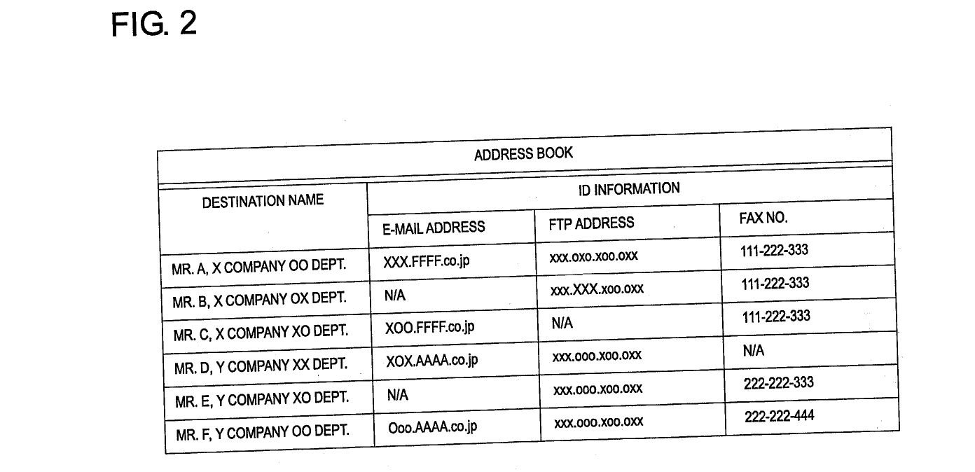

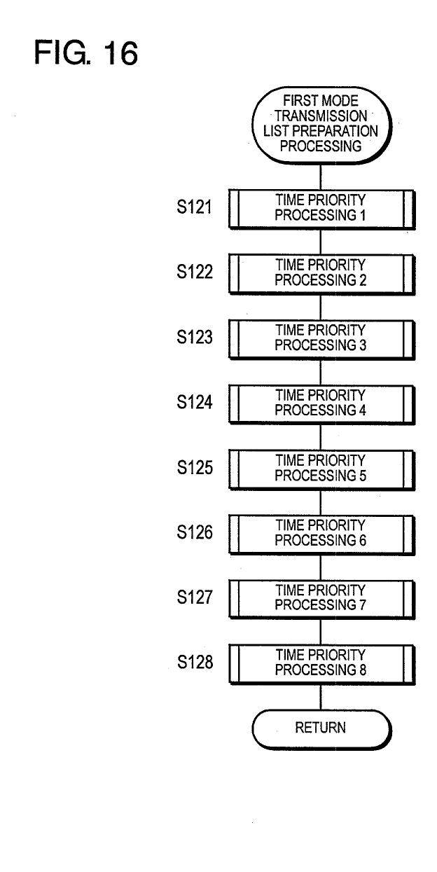

FIG. 2 1 is a flowchart of the time priority processing 5 shown in FIG. 16.

FIG. 22 is a flowchart of the time priority processing 6 shown in FIG. 16.

FIG. 23 is a flowchart of the time priority processing 7 shown in FIG. 16.

FIG. 24 is a flowchart of the time priority processing 8 shown in FIG. 16.

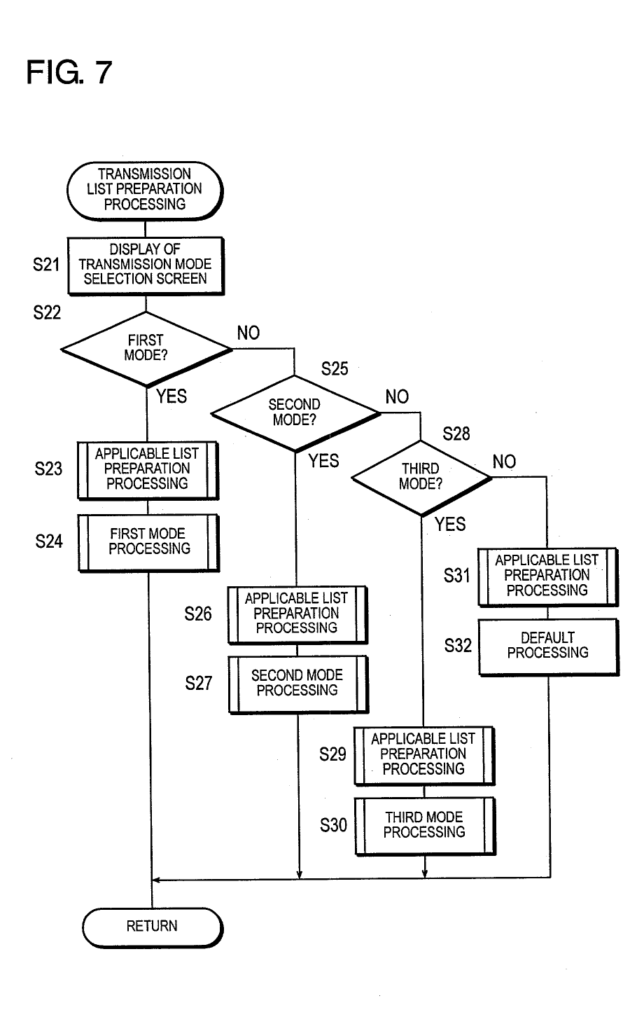

FIG. 25 is a flowchart of the second mode processing 2 shown in FIG. 7.

FIG. 26 is a flowchart of the FAX-only list preparation processing shown in FIG. 25.

FIG. 27 is a table of assistance in explaining a facsimile-only list.

FIG. 28 is a flowchart of the optimization applicable list preparation processing shown in FIG. 25.

FIG. 29 is a flowchart of the second mode transmission list preparation processing shown in FIG. 25.

FIG. 30 is a flowchart of the cost priority processing 3 shown in FIG. 29.

FIG. 31 is a flowchart of the third mode processing shown in FIG. 7.

FIG. 32 is a flowchart of the third mode transmission list preparation processing shown in FIG. 31.

FIG. 33A and FIG. 33B are flowcharts of the cost top-priority processing 3 shown in FIG. 32.

### DETAILED DESCRIPTION OF THE PREFERRED EMBODIMENT

The embodiments of this invention will be described below with reference to the accompanying drawings.

The data transmission apparatus according to the embodiment of the present invention is a facsimile apparatus having an e-mail transmission function and a file transfer function.

The data transmission apparatus is connected to a mail server and a file transfer server via a computer network for e-mail transmission and file transmission, while it is also connected to a data receiving apparatus operated by a user, for example, a facsimile apparatus via a telephone network for facsimile transmission. The mail server and the file transfer server are also connected to a data receiving apparatus, for example, a computer used by a destination, i.e., user via a computer network.

The computer network is a local area network (LAN), a wide area network (WAN), or the Internet, or a combination thereof, based on a TCP/IP (Transmission Control Protocol/Internet Protocol). The telephone network is, for example, a public telephone network.

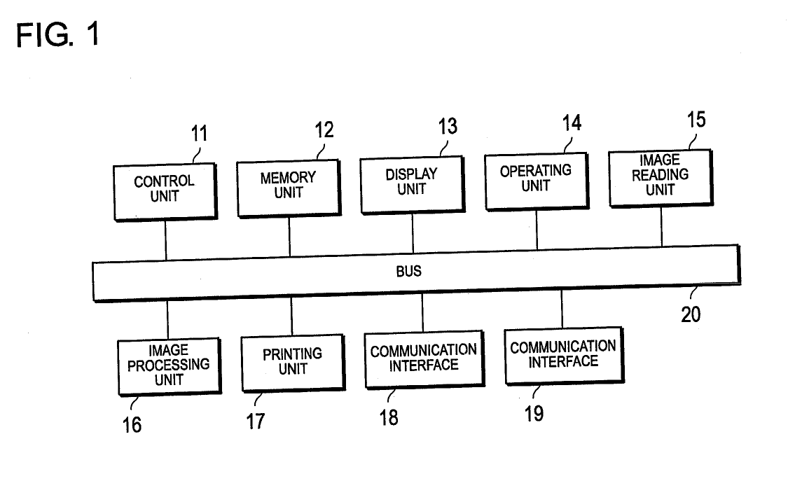

The data transmission apparatus is equipped with a control unit 11, a memory unit 12, a display unit 13, an operating unit 14, an image reading unit 15, an image processing unit 16, a printing unit 17, and communication interfaces 18 and 19, all of which are interconnected via a bus 20 as shown in FIG. 1.

The control unit 11 is a control circuit including microprocessor, etc., and controls various units 12 through 20 according to a control program such as a data transmission program.

The data transmission program uses an e-mail protocol, a file transfer protocol, and a facsimile protocol. The e-mail protocol is, for example, an SMTP (Simple Mail Transfer Protocol), and the file transfer protocol is, for example, an FTP (File Transfer Protocol).

The memory unit 12, for example, includes a read only memory device such a ROM or a flash ROM, a high speed random access memory device such as a RAM, and a high volume random access memory device such as a hard disk drive. The memory unit 12 contains a temporary memory area for storing control programs and various data as well as facsimile image files and e-mail messages, and a work area for executing the control programs.

The setting data includes an address book, a destination list, a transmission list, etc.

The address book is prepared by the source user (the user of the data transmission apparatus) and contains the destination name (the user name of the destination) and more than one item of ID (identification) information specified by the communication protocol shown in FIG. 2. The ID information includes e-mail addresses, file transfer server addresses (FTP addresses), and facsimile numbers (FAX numbers). The user name related to an e-mail address (mail account) is omitted for the sake of simplifying the process of writing. The FTP address is the IP address or domain name of the file transfer server, and includes the holder name as required.

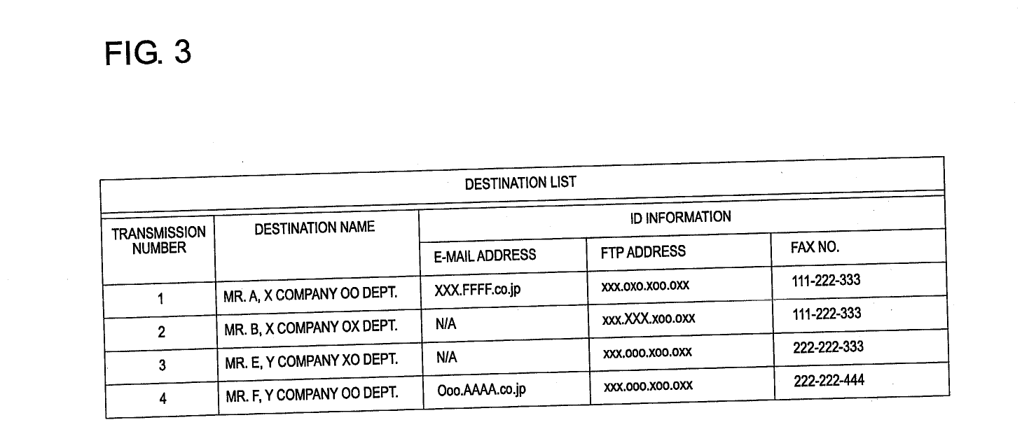

The destination list is constituted as a simple list of destination names specified by the source user as the destinations of multicasting transmission, transmission numbers indicating the order of transmission, and more than one item of ID information specified by transmission protocols, as shown in FIG. 3.

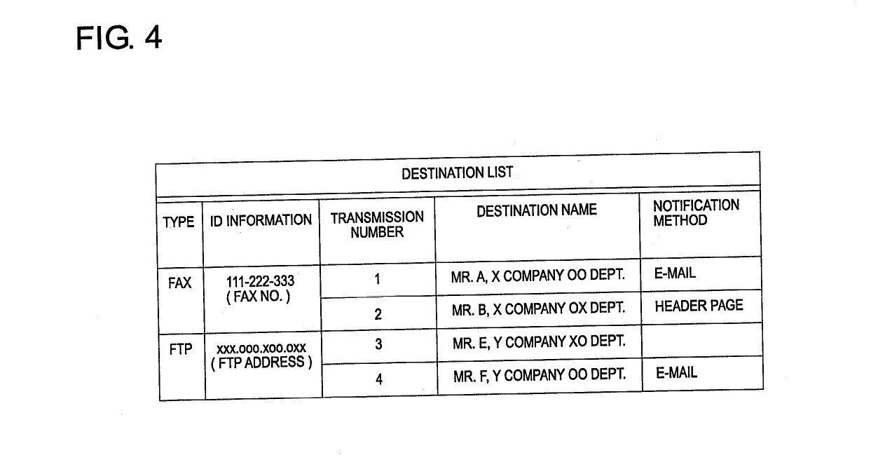

The transmission list is constituted by grouping destinations into selected transmission types and ID information (transmission protocols and addresses) as shown in FIG. 4, and is used for actual multicasting. The transmission list is automatically prepared using the transmission list based on the transmission mode selected by the source user. The “header page” in the notification method means a preparation of a facsimile header page containing all destinations in the same group and data such as a message for requesting the distribution of the facsimile message to all the destinations.

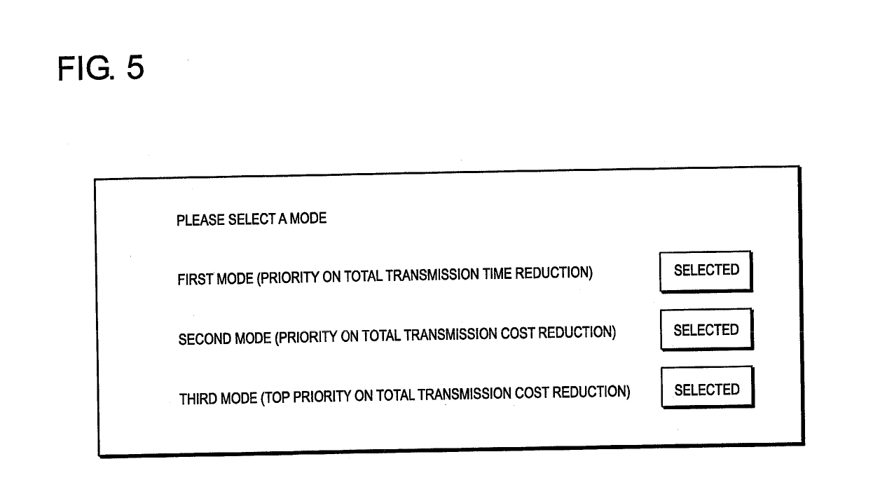

The display unit 13 has a liquid crystal display panel and is used for displaying messages for prompting selection of the transmission mode as indicated by the transmission mode selection screen shown in FIG. 5.

The operating unit 14 includes a plurality of keys and a touch panel arranged on the liquid crystal display panel of the display unit 13, and is used for inputting various items for preparing the address book and the transmission list as well as for selecting the transmission mode.

The image reading unit 15 is a scanner equipped with a CCD (Charge Coupled Device) image sensor for producing image data by reading document images and an ADF (Automatic Document Feeder) for continuously reading document images.

The image processing unit 16 executes format conversion by converting image file formats into data transmission formats. The available format conversions include conversions to the image compression method concerning the facsimile transmission, the coding method concerning files attached to e-mail messages, and the document format concerning the file transmission.

The image compression methods include the MH (Modified Huffman) method, the MR (Modified Read) method, and the MMR (Modified Modified Read) method. The data transmission methods are, for example, the Base 64, the uuencode, and the BinHex based on the MIME (Multipurpose Internet Mail Extensions) for embedding a file into the main body of an e-mail message. The document formats are, for example, the TIFF (Tagged Image File Format), which is the file format for images, and the PDF (Portable Document Format), which is the file format for displaying documents.

The printing unit 17 is an electronic photography type image forming device, and is used for outputting image files received via computer networks or telephone networks, or image files including image data generated by the image reading unit 15, on paper.

The communication interface 18 is a network interface card (NIC) and is used for sending and receiving e-mail and files. The communication interface 19 is intended for use with telephone networks and is used for sending and receiving facsimile messages.

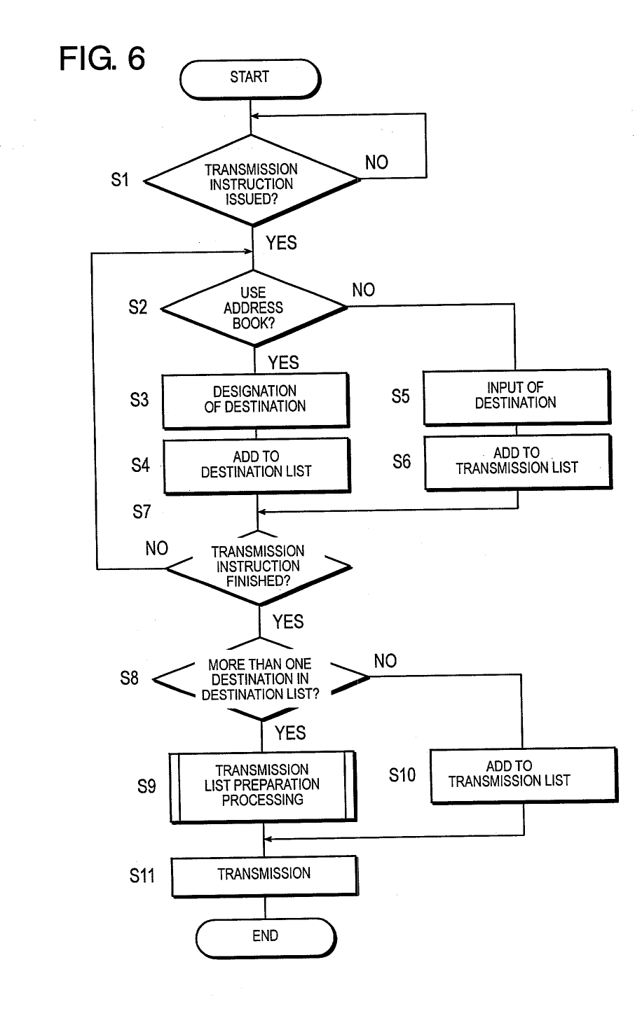

Next, the operations executed by the control unit 11 of the data transmission apparatus based on the control program will be described below referring to FIG. 6.

The control unit 11, after judging that the user has issued a transmission instruction by operating the operating unit 14 (step S1: Yes), makes another judgment as to whether the address book (refer to FIG. 2) is to be used for data input (step S2).

If it is judged that the address book is to be used, the control unit 11 displays on the display unit 13 the destinations registered on the address book and prompts the user to designate the destinations (step S3). The designated destinations are added to the destination list (refer to FIG. 3) (step S4).

If it is judged that the address book is not to be used, the control unit 11 displays the data input column on the display unit 13 to prompt the user to input the destinations (step S5). The destinations inputted are added to the transmission list (step S6).

After that, the control unit 11 makes a judgment whether the transmission instruction was finished (step S7). If it is judged that the transmission instruction is not finished, the process returns to the step S2 and the processing of the steps S2 through S6 is repeated.

If it is judged that the transmission instruction is finished, the control unit 11 makes a judgment whether the destination list includes a plurality of destinations (step S8).

If it is judged that the destination list includes a plurality of destinations, the control unit 11 executes the transmission list preparation processing to generate the transmission list (refer to FIG. 4) (step S9). If it is judged that the destination list does not include a plurality of destinations, the transmission types applicable to the destinations included in the destination list are selected and the destinations are added to the transmission list (step

The control unit 11 controls the communication interfaces 18 and 19 according to the transmission list in order to execute data transmissions using either one of the e-mail protocol, the file transfer protocol, and the facsimile protocol (step S11).

For example, with reference to the transmission list shown in FIG. 4, while a facsimile message is transmitted to the FAX number “111-222-333,” a file is transmitted to the FTP address “XXX.OOO.XOO.OXX” as well. A notification of the facsimile transmission to the destination of the transmission No. 1 is made by e-mail; a notification of the facsimile transmission to the destination of the transmission No. 2 is executed by writing about the fact on the header page; and a notification of the file transmission to the destination of the transmission No. 4 is executed by e-mail.

As can be seen from the above, in case of multicasting wherein more than one destination is included in the transmission list, data transmissions are executed by selecting an address suitable for each destination, and using a communication protocol appropriate for the destination chosen from the e-mail protocol, the file transfer protocol and the facsimile protocol. Thus, multicasting to a plurality of destinations, for which e-mail addresses, FTP addresses, and FAX numbers can be registered as communication addresses or the ID information, can be efficiently executed.

Next, the transmission list preparation processing in the step S9 will be described below referring to FIG. 7. First, the control unit 11 displays the transmission mode selection screen (refer to FIG. 5) on the display unit 13 and prompts the user to select the transmission mode (step S21).

The control unit 11 makes a judgment as to whether the user selected the first mode that prioritizes the reduction of total transmission time (step S22).

If it is judged that the user has selected the first mode, the control unit 11 executes the applicable list preparation processing and the first mode processing to automatically select an address suitable for each destination for reducing the total transmission time (steps S23 and S24). If it is judged that the user did not select the first mode, the control unit 11 makes another judgment as to whether the user selected the second mode that prioritizes the reduction of the total transmission cost (step S25).

If it is judged that the user has selected the second mode, the control unit 11 executes the applicable list preparation processing and the second mode processing to automatically select an address suitable for each destination for reducing the total transmission cost (steps S26 and S27). If it is judged that the user did not select the second mode, the control unit 11 makes another judgment as to whether the user selected the third mode that gives the top priority on the reduction of the total transmission cost (step S28).

If it is judged that the user has selected the third mode, the control unit 11 executes the applicable list preparation processing and the third mode processing to automatically select an address suitable for each destination for giving the top priority on the total transmission cost (steps S29 and S30). If it is judged that the user did not select the third mode, the control unit 11 executes the applicable list preparation processing and a default processing (step S31 and S32).

The default processing is the processing to be used when the selection of the transmission mode is omitted. Specifically, in the step S32, either one of the first mode through the third mode is executed according to the default setting, i.e., the preset priority mode.

As can be seen from the above, an address suitable for either prioritizing the total transmission time reduction, prioritizing the total transmission cost reduction, or for giving the top priority to the total transmission cost reduction is automatically selected for each destination in the transmission list preparation processing.

Next, the applicable list preparation processing executed in the steps S23, S26, S29 and S31 will be described below.

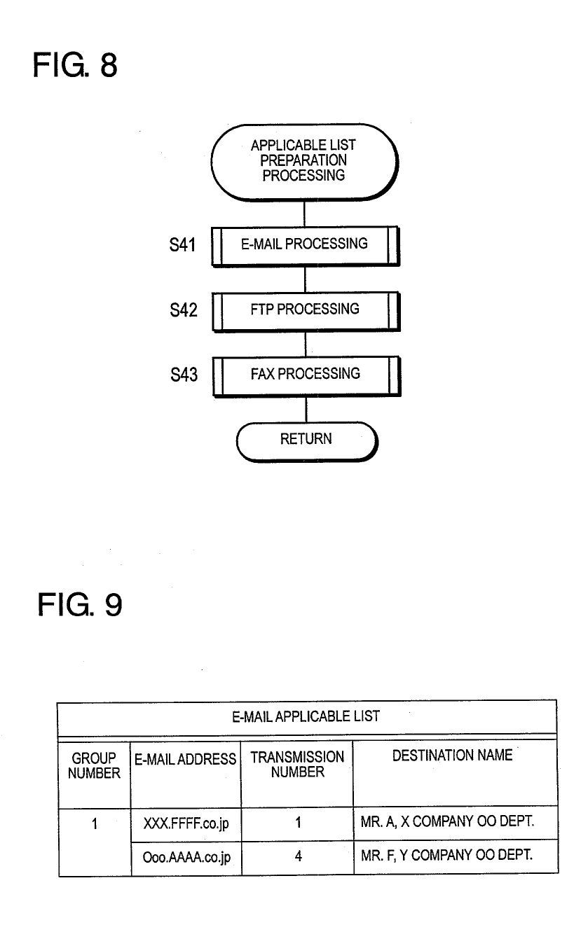

As shown in FIG. 8, the applicable list preparation processing consists of the e-mail processing (step S41), the FTP processing (step S42) and the FAX processing (step S43), and is the processing of preparing e-mail applicable list, FTP applicable list, and FAX applicable list, which are used in preparing the transmission lists for the first through third mode processing, from the destination list.

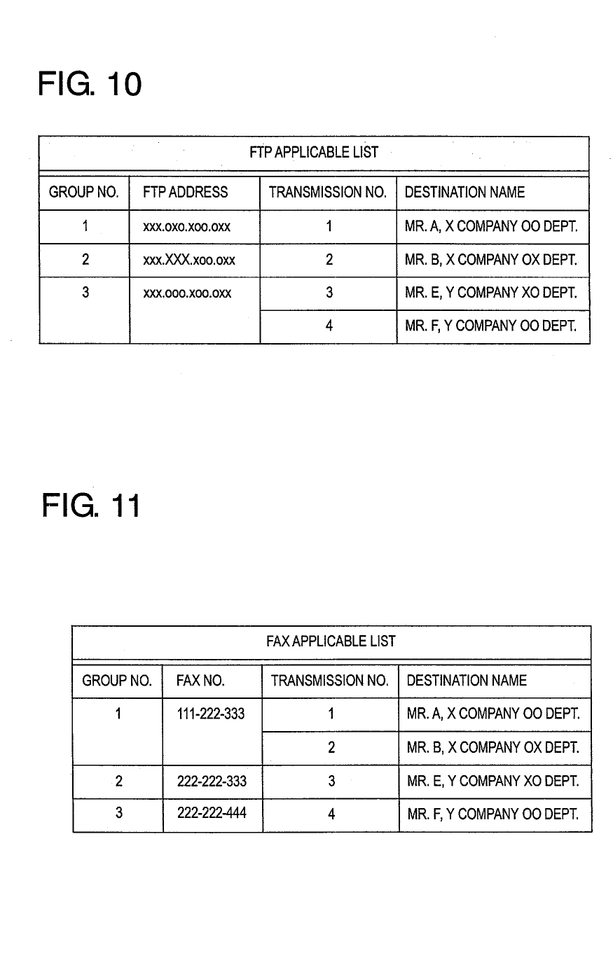

The e-mail applicable list is a list, as shown in FIG. 9, that lists, as the first group, destinations to which e-mail is applicable. The FTP applicable list is a list, as shown in FIG. 10, that lists destinations to which file transfer (FTP) is applicable, grouping them with their FTP addresses. The FAX applicable list is a list, as shown in FIG. 11, that lists destinations to which facsimile is applicable, grouping them by FAX numbers.

The number of groups corresponds to the number of transmissions. However, in case of e-mail, the grouping with their e-mail addresses is not executed as a single operation can execute data transmission to different e-mail addresses.

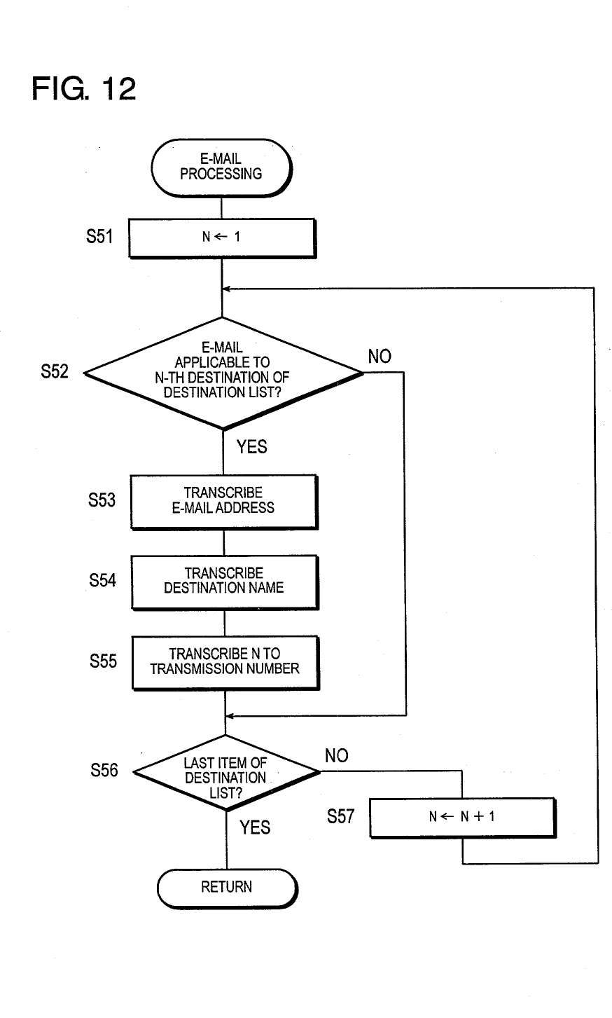

Next, the e-mail processing in the step S41 for preparing the e-mail applicable list will be described in detail referring to FIG. 12.

First, the control unit 11 sets “1” as the initial value for the parameter N (step S51).

The control unit 11 makes a judgment whether e-mail is applicable to the N-th destination (target destination) of the destination list (step S52).

If it is judged that e-mail is applicable to the target destination, the control unit 11 transcribes the e-mail address and the name of the target destination, and “N” as the transmission number to the first group of the e-mail applicable list (steps S53 through S55). If it is judged that e-mail is not applicable to the target destination, the steps S53 through S55 are skipped.

The control unit 11 then makes a judgment as to whether the target destination is the last item of the destination list (step S56). If it is judged that the target destination is not the last item of the destination list, the control unit 11 adds “1” to the value of the parameter N (step S57), and returns to the step S 52 to execute the processing to the remaining destinations.

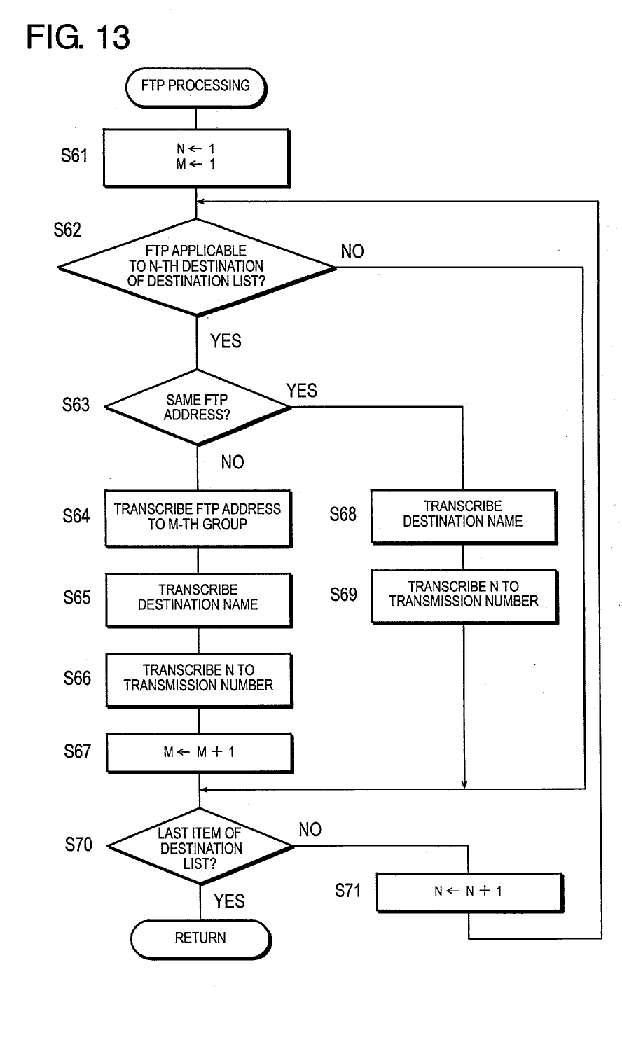

Next, the FTP processing for preparing the FTP applicable list in the step S42 in FIG. 8 will be described in detail referring to FIG. 13.

First, the control unit 11 sets “1” as the initial values to the parameters M and N (step S61).

The control unit 11 makes a judgment as to whether FTP is applicable to the N-th destination (target destination) (step S62). If it is judged that FTP is not applicable to the target destination, the steps S63 through S69 are skipped. If it is judged that FTP is applicable to the target destination, the control unit 11 further makes a judgment as to whether the same FTP address exists in current FTP applicable list (step S63).

If it is judged that the same FTP address does not exist, the control unit 11 transcribes the FTP address and the name of the target destination, and “N” as the transmission number to the M-th group of the FTP applicable list and adds “1” to the value of the parameter M (steps S64 through S67). If it is judged that the same FTP address exists, the control unit 11 transcribes the name of the target destination, and “N” as the transmission number to the M-th group of the FTP applicable list (steps S68 and S69).

Then, the control unit 11 makes a judgment whether the target destination is the last item of the destination list (step S70). If it is judged that the target destination is not the last of the destination list, the control unit 11 adds “1” to the value of the parameter N (step S71), and returns to the step S62 to execute processing for the remaining destinations.

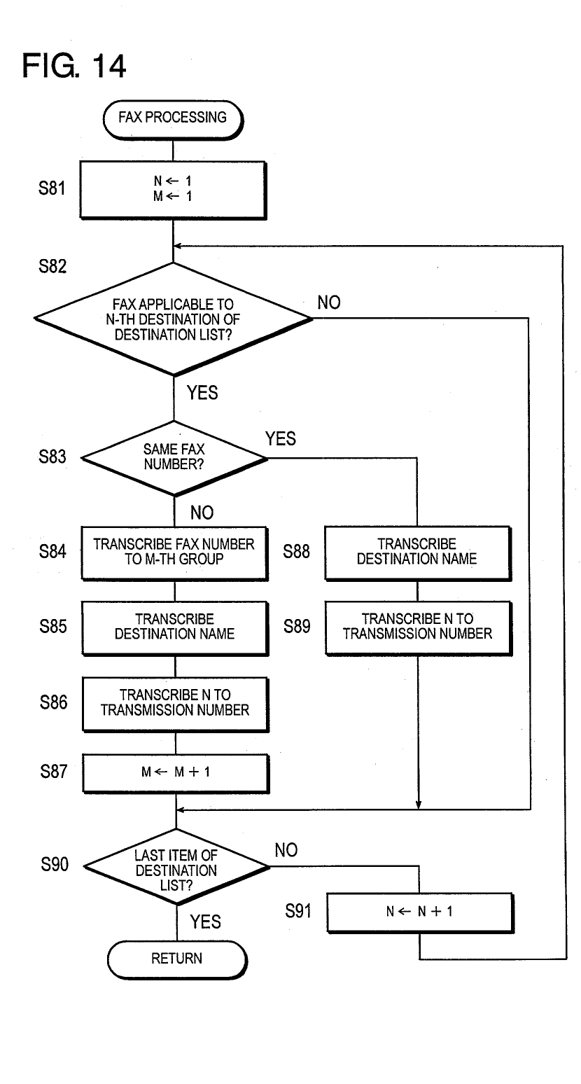

Next, the FAX processing for preparing the FAX applicable list in the step S43 shown in FIG. 8 will be described in detail referring to FIG. 14.

The control unit 11 sets “1” as the initial values for the parameters M and N (step S81).

The control unit 11 makes a judgment as to whether facsimile transmission is applicable to the N-th destination (target destination) of the transmission list (step S82). If it is judged that facsimile transmission is not applicable to the target destination, the steps S83 through S89 are skipped. If it is judged that facsimile transmission is applicable to the target destination, the control unit 11 further makes a judgment as to whether the same FAX number exists in current FAX applicable list (step S83).

If it is judged that the same FAX number does not exist, the control unit 11 transcribes the FAX number and the name of the target destination, and “N” as the transmission number to the M-th group of the FAX applicable list and adds “1” to the value of the parameter M (steps S84 through S87). If it is judged that the same FAX number exists, the control unit 11 transcribes the name of the target destination, and “N” as the transmission number to the M-th group of the FAX applicable list (steps S88 and S89).

Then, the control unit 11 makes a judgment as to whether the target destination is the last item of the destination list (step S90). If it is judged that the target destination is not the last item of the destination list, the control unit 11 adds “1” to the value of the parameter N (step S91), and returns to the step S82 to execute processing for the remaining destinations.

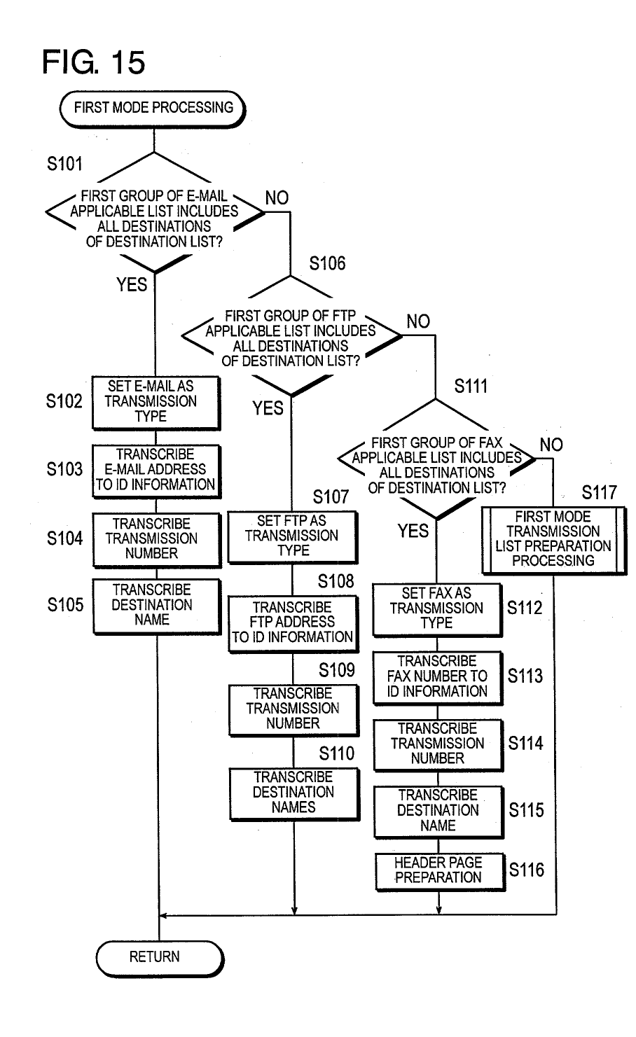

Next, the first mode processing (in the step S24 shown in FIG. 7) concerning the first mode that prioritizes the reduction of the total transmission time will be described in detail referring to FIG. 15. The reduction of the total transmission time is achieved in general by reducing the number of data transmissions by means of prioritizing the e-mail address.

First, the control unit 11 makes a judgment as to whether the first group of the e-mail applicable list includes all the destinations of the destination list (step S101). In other words, the control unit 11 makes a judgment as to whether e-mail, which is capable of transmitting data to a plurality of destinations collectively, is applicable.

If it is judged that the first group of the e-mail applicable list includes all the destinations, the control unit 11 sets e-mail as the transmission types of the transmission list (step S102), and transcribes the e-mail address (ID information) that represents the first group of the e-mail applicable list, as well as all the transmission numbers and the destination names of the first group, to the transmission list (steps S103 through S105).

If it is judged that the first group of the e-mail applicable list does not include all the destinations, the control unit 11 makes a judgment whether the first group of the FTP applicable list includes all the destinations of the destination list (step S106).

If it is judged that the first group of the FTP applicable list includes all the destinations, the control unit 11 sets FTP as the transmission types of the transmission list (step S107), and transcribes the FTP address (ID information) that represents the first group of the FTP applicable list, as well as all the transmission numbers and the destination names of the first group, to the transmission list (steps S108 through S110).

If it is judged that the first group of the FTP applicable list does not include all the destinations, the control unit 11 makes a judgment whether the first group of the FAX applicable list includes all the destination of the destination list (step Sill).

If it is judged that the first group of the FAX applicable list includes all the destinations, the control unit 11 sets FAX as the transmission types of the transmission list (step S112), and transcribes the FAX number (ID information) that represents the first group of the FAX applicable list, as well as all the transmission numbers and the destination names of the first group, to the transmission list (steps S113 through S115).

The control unit 11 then registers a preparation instruction for a facsimile header page in the notification method column of the transmission list, to which the first group data of the FAX applicable list is transcribed (step S116). The header page contains all the destinations concerning the first group, and a message requesting circulation of the message.

If it is judged that the first group of the FAX applicable list does not include all the destinations, the control unit 11 executes a first mode transmission list preparation processing (step S117).

Therefore, if the data transmission can be finished in one operation in the first mode processing, the preference is given to the mail address, FTP address and FAX number in that order, considering the total transmission cost; however, if more than one data transmission is required, the first mode transmission list preparation processing is executed for reducing the number of data transmissions.

Thus, the first mode transmission list preparation processing will be described in detail.

The first mode transmission list preparation processing consists of the time priority processing 1 through 8 (steps S121 through S128) as shown in FIG. 16.

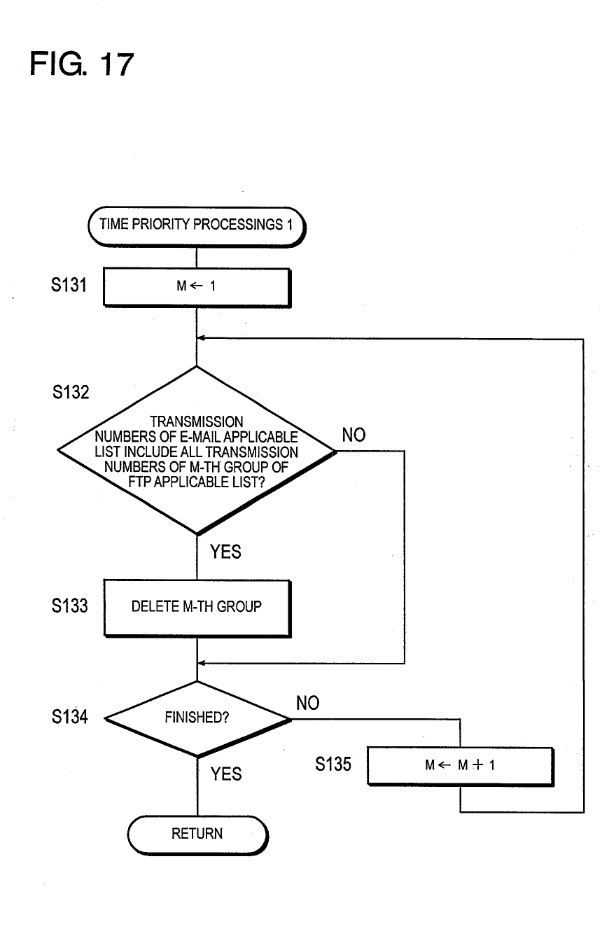

The time priority processing 1 in the step S121 will be described below referring to FIG. 17.

The control unit 11 sets “1” to the parameter M as the initial value (step S131).

Then, the control unit 11 makes a judgment as to whether all the transmission numbers of the M-th group (target group) of the FTP applicable list are included in the transmission numbers of the e-mail applicable list (step S132).

If it is judged that all of the transmission numbers of the target group are included in the transmission numbers of the e-mail applicable list, the control unit 11 deletes the target group from the FTP applicable list (step S133). If it is judged that not all of the transmission numbers of the target group are included in the transmission numbers of the e-mail applicable list, the step S133 is skipped.

After that, the control unit 11 makes a judgment as to whether the processing for the entire groups of the FTP applicable list is finished (step S134). If it is judged that the processing is not finished, the control unit 11 adds “1” to the value of the parameter M (step S135), and returns to the step S132 to execute the processing for the remaining groups.

Thus, in the time priority processing 1, if all the transmission numbers of the target group of the FTP applicable list are included in the transmission numbers of the e-mail applicable list, the FTP transmission can be omitted, so that the number of the FTP transmissions can be reduced by eliminating the target group.

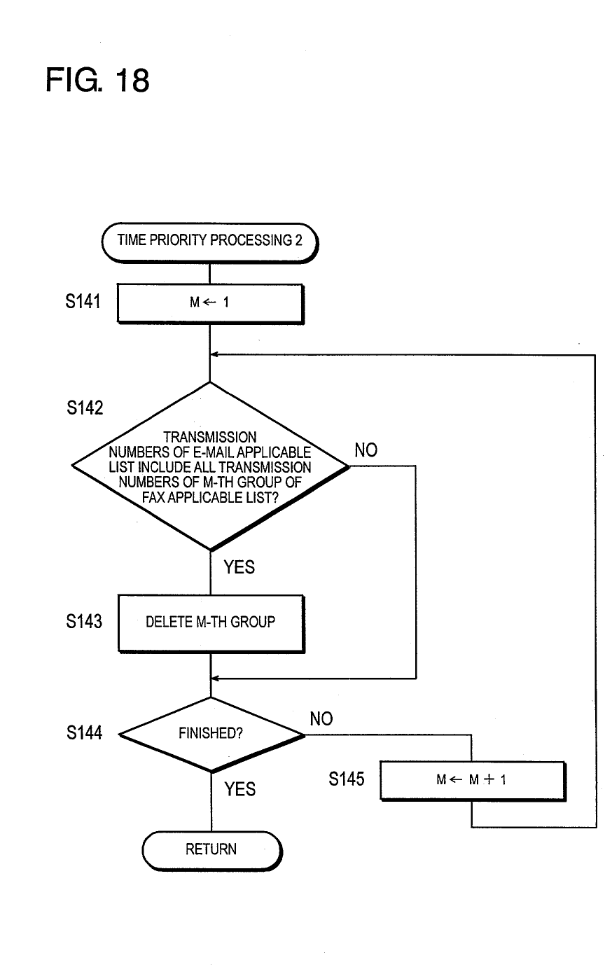

Next, the time priority processing 2 in the step S122 will be described below referring to FIG. 18.

First, the control unit 11 sets “1” to the parameter M as the initial value (step S141).

The control unit 11 makes a judgment as to whether all the transmission numbers of the M-th group (target group) of the FAX applicable list are included in the transmission numbers of the e-mail applicable list (step S142).

If it is judged that all of the transmission numbers of the target group are included in the transmission numbers of the e-mail applicable list, the control unit 11 deletes the target group from the FAX applicable list (step S143). If it is judged that not all of the transmission numbers of the target group are included in the transmission numbers of the e-mail applicable list, the step S143 is skipped.

Then, the control unit 11 makes a judgment as to whether the processing for the entire groups of the FAX applicable list is finished (step S144). If it is judged that the processing is not finished, the control unit 11 adds “1” to the value of the parameter M (step S145), and returns to the step S142 to execute the processing for the remaining groups.

Thus, in the time priority processing 2, if all the transmission numbers of the target group of the FAX applicable list are included in the transmission numbers of the e-mail applicable list, the facsimile transmission can be omitted, so that the number of the facsimile transmissions can be reduced by eliminating the target group.

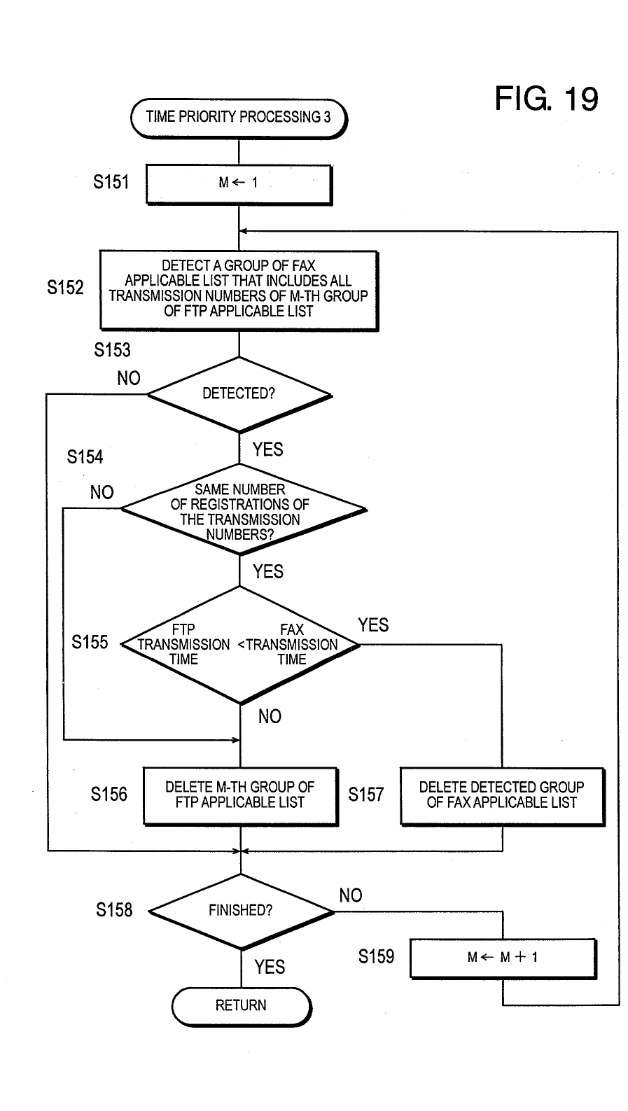

Next, the time priority processing 3 in the step S123 will be described below referring to FIG. 19.

First, the control unit 11 sets “1” to the parameter M as the initial value (step S151), and detects a group of the FAX applicable list that contains all the transmission numbers of the M-th group (target group) of the FTP applicable list (step S152).

Then, the control unit 11 makes a judgment as to whether any group is detected (step S153). If it is judged that no group is detected, the process advances to the step S158. If it is judged that a group is detected, the control unit 11 compares the target group with the detected group concerning the number of registrations of the transmission numbers (step S154).

If it is judged that the number of registered transmission numbers is not identical, the step S155 is skipped. If it is judged that the number of registered transmission numbers is identical, the control unit 11 compares the file transfer time (FTP transmission time) with the facsimile transmission time (FAX transmission time) (step S155). If it is judged that the FTP transmission time is shorter than the FAX transmission time, the control unit 11 deletes the detected group from the FAX applicable list (step S157) and the process proceeds to the step S158.

If it is judged that the FTP transmission time is not shorter than the FAX transmission time, the control unit 11 deletes the target group from the FTP applicable list (S156), and the process advances to the step S158.

In the step S158, the control unit 11 makes a judgment as to whether the processing to all the groups of the FTP applicable list is finished (step S158). If it is judged that the processing is not finished, the control unit 11 adds “1” to the value of the parameter M (step S159), and returns to the step S152 to execute the processing for the remaining groups.

Thus, in the time priority processing 3, if the transmission numbers of the target group of the FTP applicable list match completely with the transmission numbers of a specific group of the FAX applicable list, the reduction effect of the total transmission time is enhanced by deleting the group with a longer transmission time. Moreover, if some transmission numbers other than the transmission numbers of the target group are included in the specific group, the facsimile transmissions cannot be omitted, so that the number of the FTP transmissions is reduced by deleting the target group.

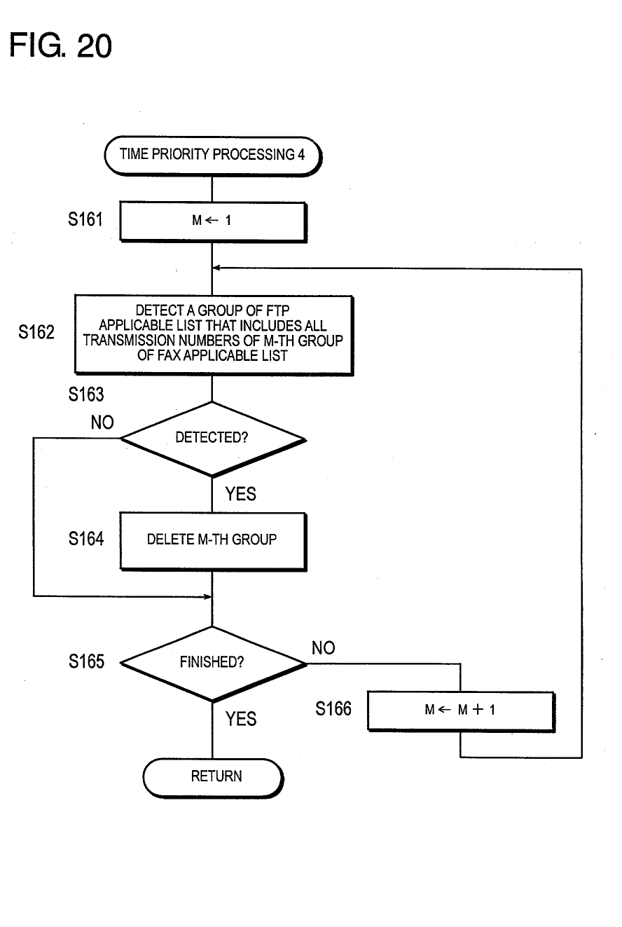

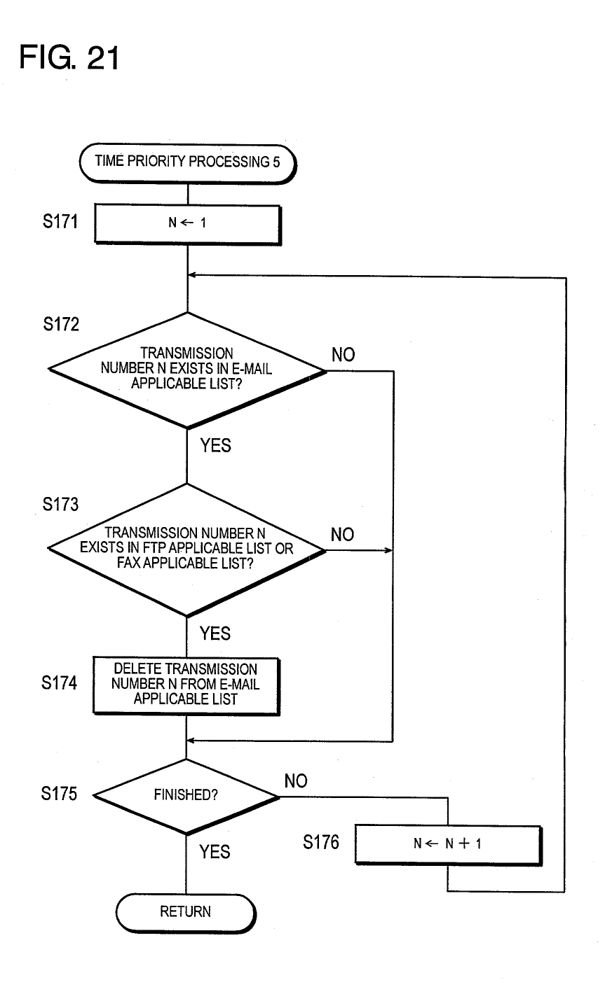

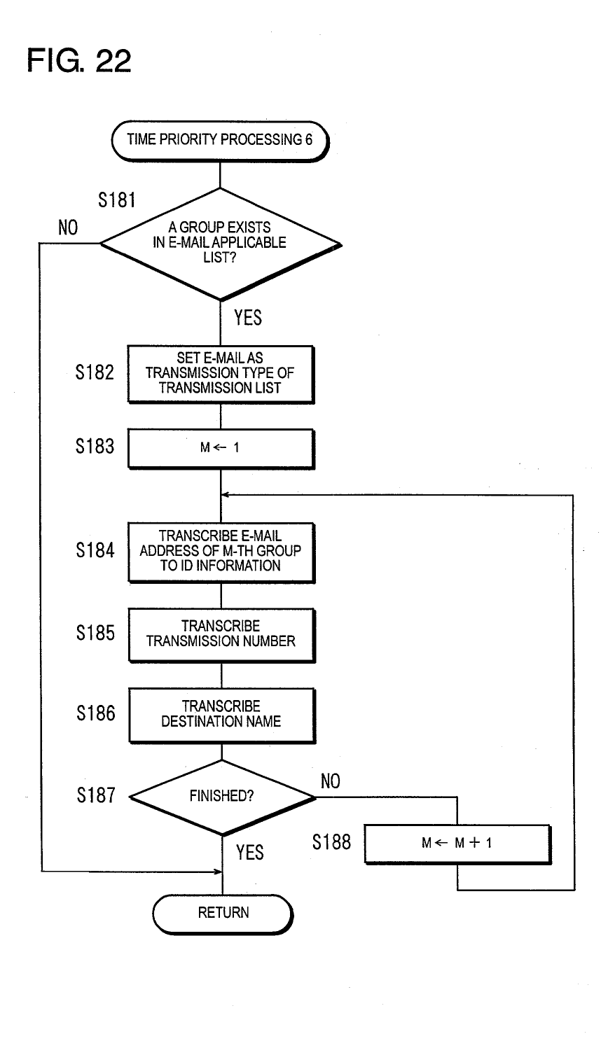

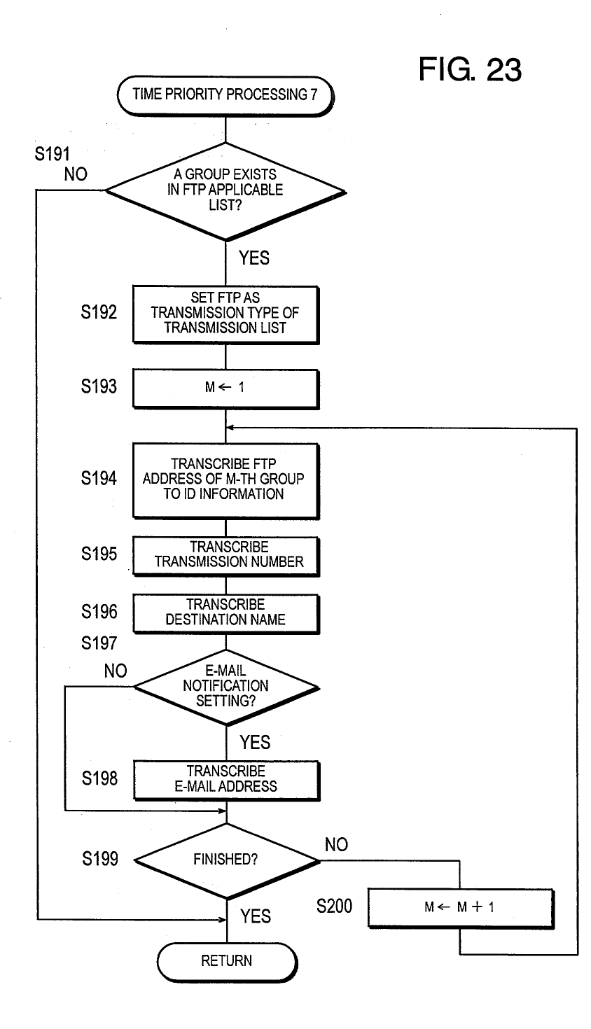

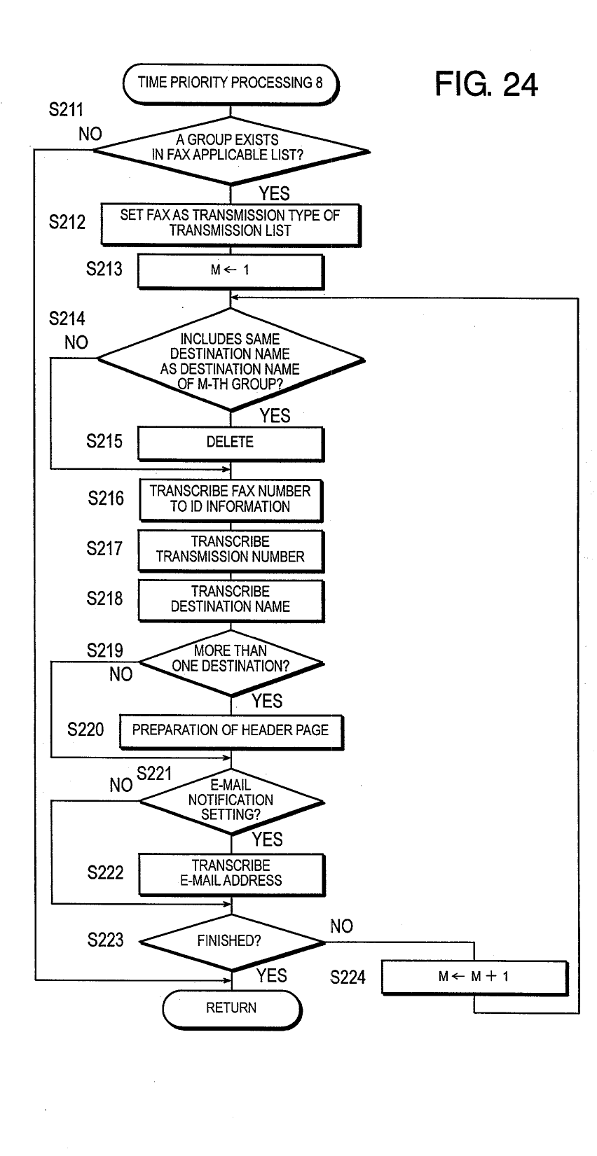

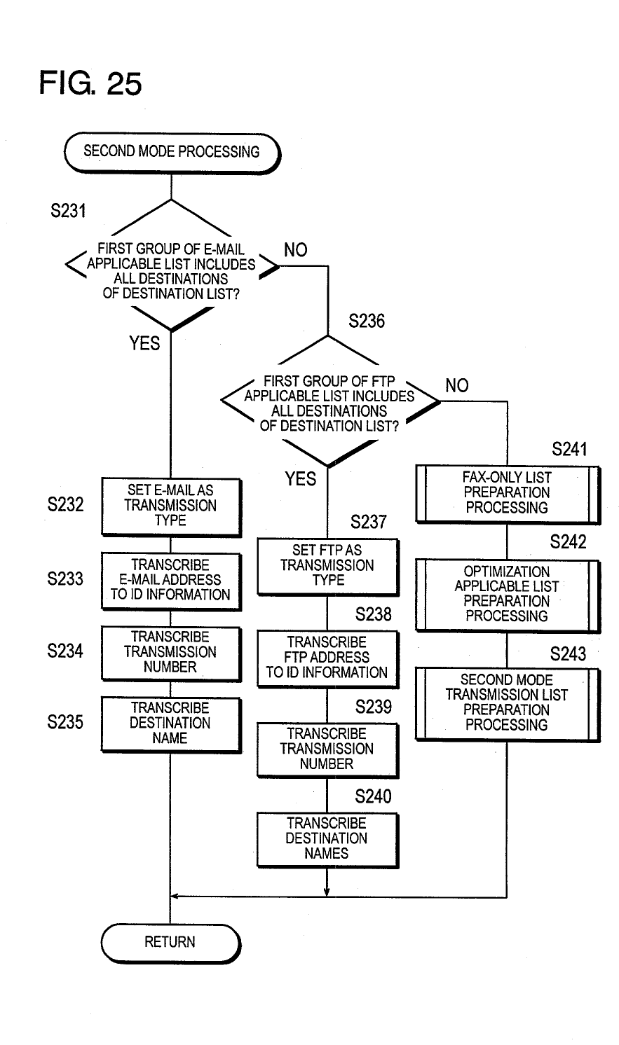

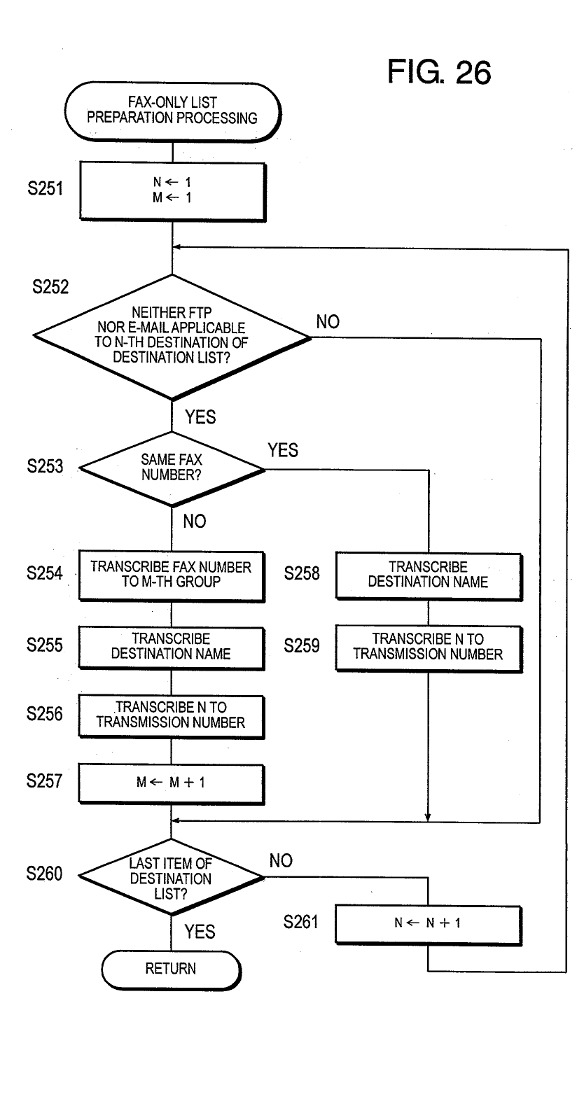

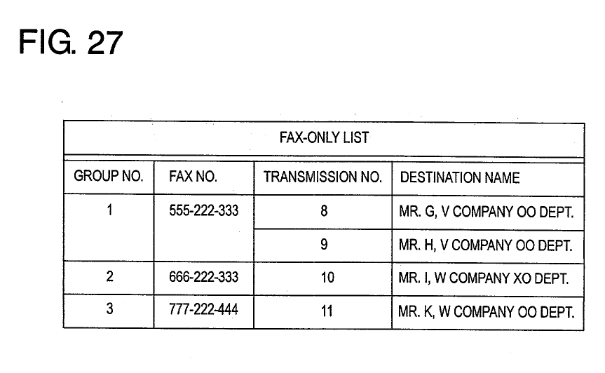

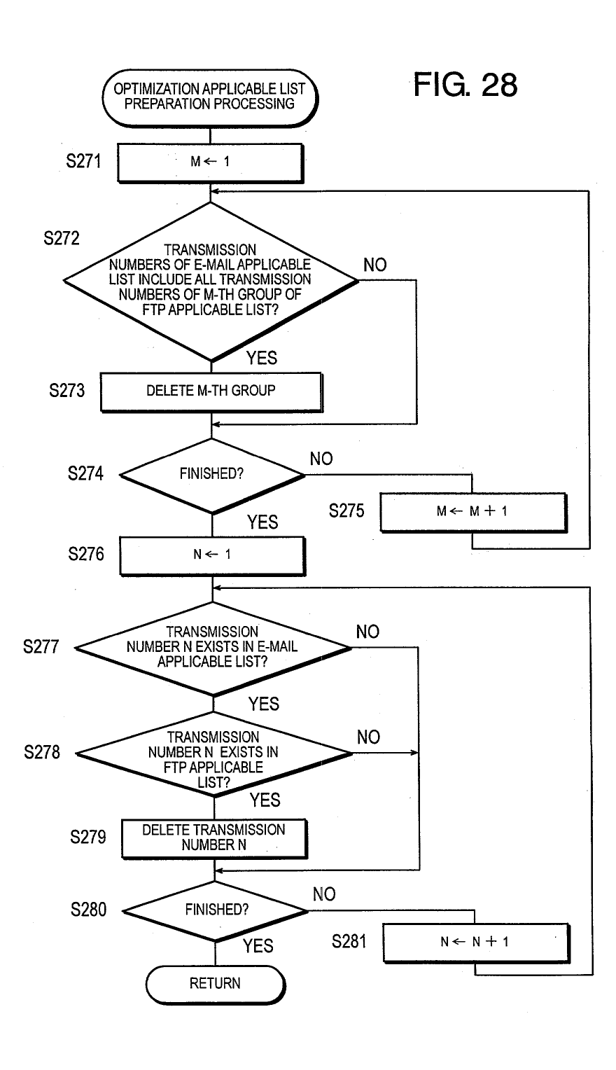

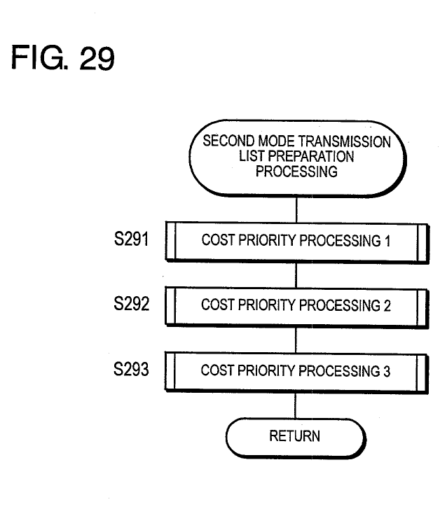

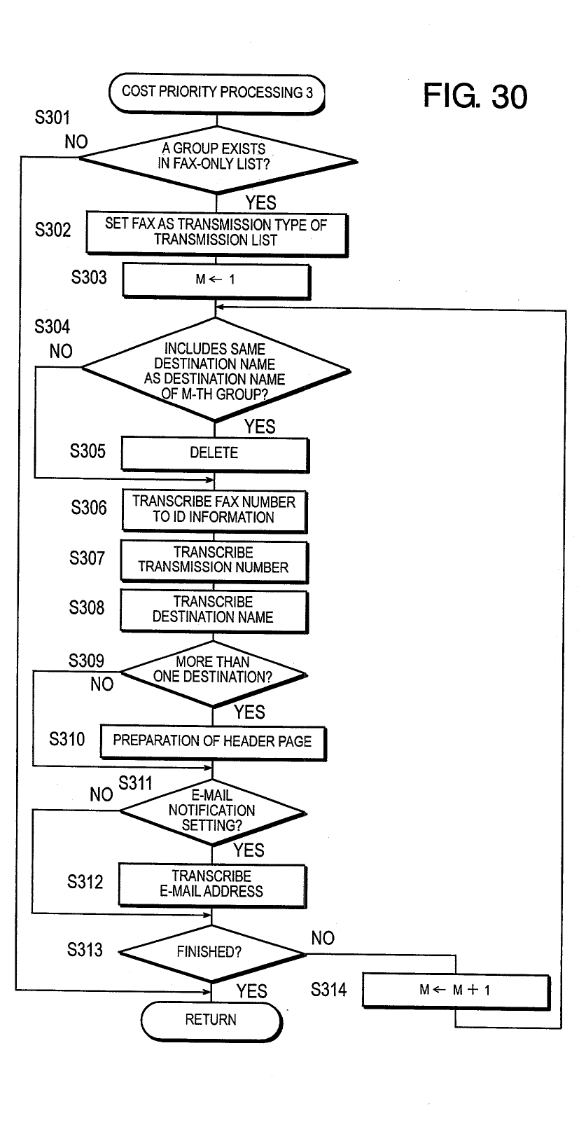

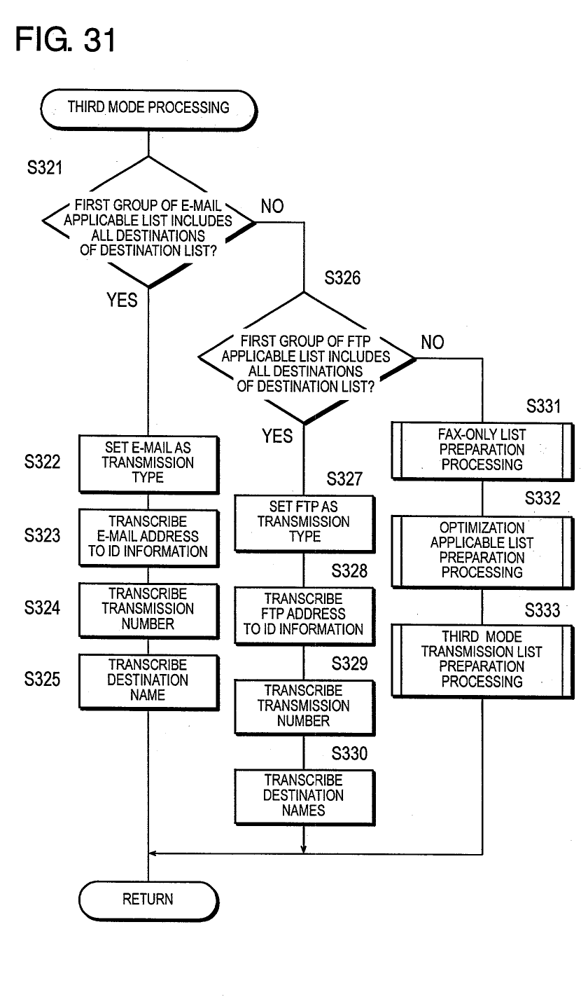

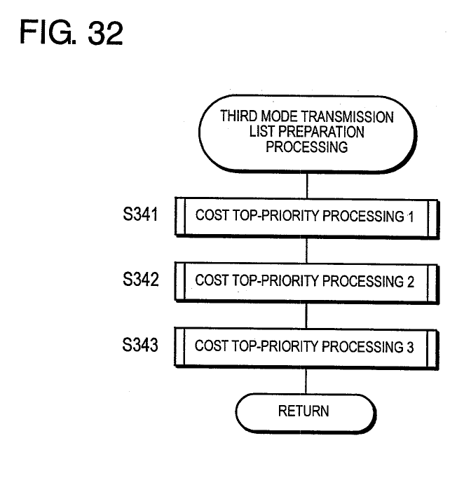

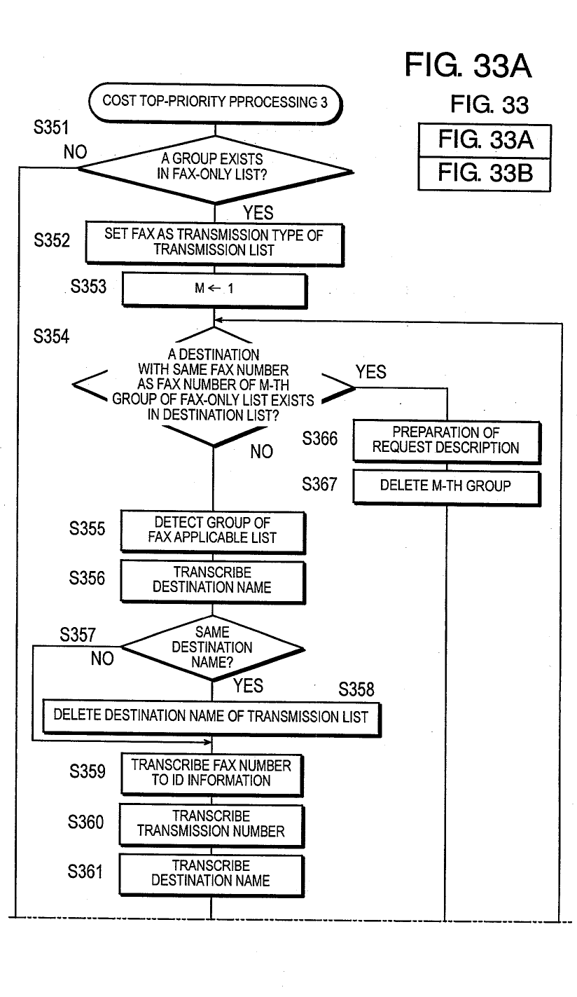

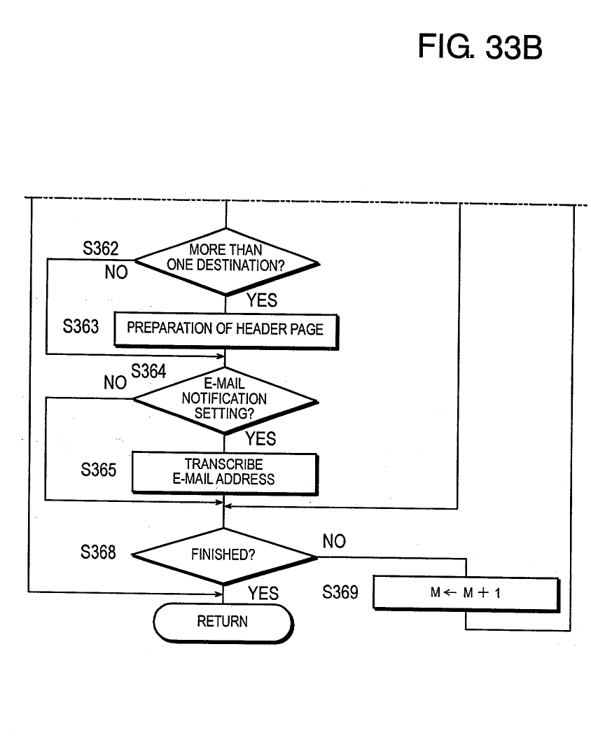

Next, the time priority processing 4 in the step S124 will be described below referring to FIG. 20.

First, the control unit 11 sets “1” to the parameter M as the initial value (step S161), and detects a group of the FTP applicable list that contains all the transmission numbers of the M-th group (target group) of the FAX applicable list (step S162).

Then, the control unit 11 makes a judgment as to whether any group is detected (step S163). If it is judged that no group is detected, the step S164 is skipped. If it is judged that a group is detected, the control unit 11 deletes the target group from the FAX applicable list (step S164).

Subsequently, the control unit 11 makes a judgment as to whether the processing to all the groups of the FAX applicable list is finished (step S165). If it is judged that the processing is not finished, the control unit 11 adds “1” to the value of the parameter M (step S166), and returns to the step S162 to execute the processing for the remaining groups.

Thus, in the time priority processing 4, if the transmission numbers of the target group of the FAX applicable list are included in the transmission numbers of the FTP applicable list, the facsimile transmissions can be omitted, so that the number of facsimile transmissions can be reduced by deleting the target group.

Next, the time priority processing 5 in the step S125 will be described below referring to FIG. 21.

First, the control unit 11 sets “1” to the parameter N as the initial value (step S171), and makes a judgment as to whether the transmission number N exists in the e-mail applicable list (step S172).

If it is judged that the transmission number N does not exist, the process advances to the step S175. If it is judged that the transmission number N exists, the control unit 11 makes a judgment as to whether the transmission number N exists in the FTP applicable list or the FAX applicable list (step S173). If it is judged that the transmission number N does not exist, the process advances to the step S175. If it is judged that the transmission number N exists, the control unit 11 deletes the transmission number N from the e-mail applicable list (step S174), and the process advances to the step S175.

In the step S175, the control unit 11 makes a judgment as to whether the processing concerning all the transmission numbers of the e-mail applicable list is finished (step S175). If it is judged that the processing is not finished, the control unit 11 adds “1” to the value of the parameter N (step S176), and returns to the step S172 to execute the processing for the remaining transmission numbers.

Thus, in the time priority processing 5, if a transmission number contained in the e-mail applicable list also exists in the FTP applicable list or the FAX applicable list, the e-mail can be omitted, so that the e-mail transmission operation can be simplified by deleting the transmission number from the e-mail applicable list.

Next, the time priority processing 6 in the step S126 will be described below referring to FIG. 22.

First, the control unit 11 makes a judgment whether any group exists in the e-mail applicable list (step S181).

If it is judged that no group exists in the e-mail applicable list, the process terminates. If it is judged that there is a group in the e-mail applicable list, the control unit 11 sets e-mail as the transmission types of the transmission list (step S182), and sets “1” to the parameter M as the initial value (step S183).

Then, the control unit 11 transcribes e-mail addresses, transmission numbers and the destination names of the M-th group of the e-mail applicable list to the transmission list (step S184 through S186).

The control unit 11 makes a judgment whether the processing to all the groups in the e-mail applicable list is finished (step S187). If it is judged that the processing is not finished, the control unit 11 adds “1” to the value of the parameter M (step S188), and returns to the step S184 to execute the processing for the remaining groups.

Thus, in the time priority processing 6, the e-mail related portion of the transmission list is prepared based on the e-mail applicable list corrected by the time priority processing 5.

Next, the time priority processing 7 concerning the step S127 will be described below referring to FIG. 23.

First, the control unit 11 makes a judgment as to whether there are any groups in the FTP applicable list (step S191).

If it is judged that no group exists in the FTP applicable list, the process terminates. If it is judged that there is a group in the FTP applicable list, the control unit 11 sets FTP as the transmission types of the transmission list (step S192),and sets “1” to the parameter M as the initial value (step S193).

Then, the control unit 11 transcribes the FTP address that represents the M-th group (target group) of the FTP applicable list, as well as all the transmission numbers and the destination names of the group, to the transmission list (step S194 through S196).

The control unit 11 then makes a judgment as to whether the e-mail notification is set for the destinations for the target group (step S197). If it is judged that the e-mail notification is set, the control unit 11 additionally transcribes the e-mail addresses of the destinations to the notification method provided in the transmission list column, to which the data of the destinations are transcribed (step S198). If it is judged that the e-mail notification is not set, the step S198 is skipped.

After that, the control unit 11 makes a judgment whether the processing to all the groups of the FTP applicable list is finished (step S199). If it is judged that the processing is not finished, the control unit 11 adds “1” to the value of the parameter M (step S200), and returns to the step S194 to execute the processing for the remaining groups.

Thus, in the time priority processing 7, the FTP related portion of the transmission list is prepared based on the FTP applicable list corrected by the time priority processing 1 and 3.

Next, the time priority processing 8 concerning the step S128 will be described below referring to FIG. 24.

First, the control unit 11 makes a judgment as to whether there are any groups in the FAX applicable list (step S211).

If it is judged that no group exists in the FAX applicable list, the process terminates. If it is judged that there is a group in the FAX applicable list, the control unit 11 sets FAX as the transmission types of the transmission list (step S212), and sets “1” to the parameter M as the initial value (step S213).

Then, the control unit 11 makes a judgment as to whether a destination name identical to the destination name of the M-th group (target group) of the FAX applicable list is included in the transmission list (step S214).

If it is judged that an identical name is included, the control unit 11 deletes the destination name from the transmission list (step S215). If it is judged that no identical name is included, the step S215 is skipped.

The control unit 11 transcribes FAX number that represents the M-th group (target group) of the FAX applicable list as well as all the transmission numbers and destination names to the transmission list (step S216 through S218).

Then, the control unit 11 makes a judgment as to whether more than one destination exists in the target group (step S219). If it is judged that more than one destination exists, the control unit 11 registers an instruction for preparing the facsimile header page to the notification method provided in the transmission list column, to which the data of the target group are transcribed (step S220). If it is judged that is only one destination, the step S220 is skipped.

The control unit 11 then makes a judgment as to whether the e-mail notification is set for the destinations for the target group (step S221). If it is judged that the e-mail notification is set, the control unit 11 additionally transcribes the e-mail addresses of the destinations to the notification method provided in the transmission list column, to which the data of the destinations are transcribed (step S222). If it is judged that the e-mail notification is not set, the step S222 is skipped.

After that, the control unit 11 makes a judgment whether the processing to all the groups of the FAX applicable list is finished (step S223). If it is judged that the processing is not finished, the control unit 11 adds “1” to the value of the parameter M (step S224), and returns to the step S214 to execute the processing for the remaining groups.

Thus, in the time priority processing 8, the FAX related portion of the transmission list is prepared based on the FAX applicable list corrected by the time priority processing 2, 3 and 4. Moreover, the FAX transmission to more than one destination of the same group can be executed by a single transmission by adding data to the facsimile header page that it is for a plurality of destinations.

Next, the second mode processing (in the step S27 shown in FIG. 7) concerning the second mode for prioritizing the reduction of the total transmission cost will be described below referring to FIG. 25. The reduction of the total transmission cost is achieved generally by means of giving priority to e-mail and file transfer via computer networks.

First, the control unit 11 makes a judgment as to whether all the destinations of the destination list are included in the first group of the e-mail applicable list (step S231).

If it is judged that all the destinations are included in the first group of the e-mail applicable list, the control unit 11 sets e-mail as the transmission type of the transmission list (step S232), and transcribes the e-mail address that represents the first group of the e-mail applicable list, as well as all the transmission numbers and the destination names of the first group to the transmission list (steps S233 through S235).

If it is judged that the first group of the e-mail applicable list does not include all the destinations, the control unit 11 makes a judgment whether the first group of the FTP applicable list includes all the destinations of the destination list (step S236).

If it is judged that the first group of the FTP applicable list includes all the destinations, the control unit 11 sets FTP as the transmission type of the transmission list (step S237), and transcribes the FTP address (ID information) that represents the first group of the FTP applicable list, as well as all the transmission numbers and the destination names of the first group, to the transmission list (steps S238 through S240).

If it is judged that the first group of the FTP applicable list does not include all the destinations, the control unit 11 sequentially executes a FAX-only list preparation processing, an optimization applicable list preparation processing, and a second mode transmission list preparation processing in that order (step S241 through S243).

Thus, in the second mode processing, if the data transmission to more than one destinations can be accomplished by a single transmission by means of e-mail or file transfer, it is used with priority on e-mail addresses and FTP addresses in that order, while, in other cases, the FAX-only list preparation processing, optimization applicable list preparation processing, and second mode transmission list preparation processing are executed.

The FAX-only list preparation processing in the step S241 will be described below referring to FIG. 26. The FAX-only list is a list where the destinations, to which facsimile transmissions are only applicable, are grouped together by FAX numbers as shown in FIG. 27.

First, the control unit 11 sets “1” to the parameters M and N as initial values (step S251).

The control unit 11 makes a judgment as to whether FTP and/or e-mail are applicable to the N-th destination (target destination) of the destination list (step S252). If it is judged that FTP and/or e-mail are applicable to the target destination, the process advances to the step S260. If only facsimile is applicable to a destination, the control unit 11 makes a decision if the same FAX number exists in the current FAX-only list (step S253).

If it is judged that the same FAX number does not exist, the control unit 11 transcribes the FAX number and the name of the target destination, and “N” as the transmission number to the M-th group of the FAX-only list and adds “1” to the value of the parameter M (step S254 through S257). If it is judged that the same FAX number exists, the control unit 11 transcribes the name of the target destination, and “N” as the transmission number to the M-th group of the FAX applicable list (step S258 through S259).

Then, the control unit 11 makes a judgment as to whether the target destination is the last item of the destination list (step S260). If it is judged that the target destination is not the last item of the destination list, the control unit 11 adds “1” to the value of the parameter N (step S261), and returns to the step S252 to execute processing for the remaining destinations.

Next, the optimization applicable list preparation processing in the step S242 will be described below referring to FIG. 28.

First, the control unit 11 sets “1” to the parameter M as initial value (step S271).

The control unit 11 makes a judgment as to whether all the transmission numbers of the M-th group (target group) of the FTP applicable list are included in the transmission numbers of the e-mail applicable list (step S272).

If it is judged that all of the transmission numbers of the target group are included in the transmission numbers of the e-mail applicable list, the control unit 11 deletes the target group from the FTP applicable list (step S273). If it is judged that not all of the transmission numbers of the target group are included in the transmission numbers of the e-mail applicable list, the step S273 is skipped.

Then, the control unit 11 makes a judgment as to whether the processing for the entire groups of the FTP applicable list is finished (step S274). If it is judged that the processing is not finished, the control unit 11 adds “1” to the value of the parameter M (step S275), and returns to the step S272 to execute the processing for the remaining groups.

If it is judged that the processing is finished, the control unit 11 sets “1” to the parameter N as the initial value (step S276).

After that, the control unit 11 makes a judgment as to whether the transmission number N exists in the e-mail applicable list (step S277). If it is judged that the transmission number N does not exist in the e-mail applicable list, the steps S278 and S279 are skipped. If it is judged that the transmission number N exists in the e-mail applicable list, the control unit 11 makes a judgment as to whether it exists in the FTP applicable list (step S278).

If it is judged that the transmission number N does not exist in the FTP applicable list, the step S279 is skipped. If it is judged that the transmission number N exists in the FTP applicable list, the control unit 11 deletes the transmission number N from the e-mail applicable list (step S279).

Then, the control unit 11 makes a judgment as to whether the processing for the entire groups of the e-mail applicable list is finished (step S280). If it is judged that the processing is not finished, the control unit 11 adds “1” to the value of the parameter N (step S281), and returns to the step S277 to execute the processing for the remaining groups.

Thus, the e-mail applicable list and the FTP applicable list are optimized in the optimization applicable list preparation processing. Since the FTP transmission can be omitted if all the transmission numbers of the target group of the FTP applicable list are included in the transmission numbers of the e-mail applicable list, the number of FTP transmissions can be reduced. Moreover, if the transmission numbers of the e-mail applicable list are included in the FTP applicable list, the e-mail transmission operation can be simplified by deleting the numbers from the e-mail applicable list.

Next, the second mode transmission list preparation processing in the step S243 will be described below.

The second mode transmission list preparation processing consists of the cost priority processing 1 through 3 as shown in FIG. 29.

Since the cost priority processing 1 is the processing of preparing the e-mail portion of the transmission list based on the e-mail applicable list corrected by the optimization applicable list preparation processing, and is similar to the time priority processing 6 in the first mode transmission list preparation processing, its description is not repeated here. Furthermore, since the cost priority processing 2 is the processing of preparing the FTP portion of the transmission list based on the FTP applicable list corrected by the optimization applicable list preparation processing, and is similar to the time priority processing 7 in the first mode transmission list preparation processing, its description is not repeated here.

Thus, the cost priority processing 3 in the step S293 will be described below referring to FIG. 30.

The control unit 11 makes a judgment as to whether any group exists in the FAX-only list (step S301).

If it is judged that no group exists in the FAX-only list, the process terminates. If it is judged that one or more groups exist in the FAX-only list, the control unit 11 sets FAX as the transmission type for the transmission list (step S302), and sets “1” to the parameter M as the initial value (step S303).

The control unit 11 then makes a judgment as to whether a destination name identical to the destination name of the M-th group (target group) of the FAX-only list is included in the transmission list (step S304).

If it is judged that an identical name is included, the control unit 11 deletes a destination having the identical name from the transmission list (step S305). If it is judged that no identical name is included, the step S305 is skipped.

Then, the control unit 11 transcribes FAX number that represents the target group, as well as all the transmission numbers and destination names of the target group, to the transmission list (step S306 through S308).

The control unit 11 makes a judgment as to whether more than one destination exists in the target group (step S309). If it is judged that more than one destination exists, the control unit 11 registers a preparation instruction for the facsimile header page to the notification method provided in the transmission list column, to which the data of the target group are transcribed (step S310). If it is judged that only one destination exists, the step S310 is skipped.

The control unit 11 then makes a judgment as to whether the e-mail notification is set for the destinations for the target group (step S311). If it is judged that the e-mail notification is set, the control unit 11 additionally transcribes the e-mail addresses of the destinations to the notification method provided in the transmission list column, to which the data of the destinations are transcribed (step S312). If it is judged that the e-mail notification is not set, the step S312 is skipped.

After that, the control unit 11 makes a judgment whether the processing to all the groups of the FAX applicable list is finished (step S313). If it is judged that the processing is not finished, the control unit 11 adds “1” to the value of the parameter M (step S314), and returns to the step S304 to execute the processing for the remaining groups.

Thus, in the cost priority processing 3, the FAX portion of the transmission list is prepared based on the FAX-only list, not on the FAX applicable list. Therefore, the use of facsimile transmission, which is a protocol of a higher cost, is avoided.

Next, the third mode processing (in the step S30 shown in FIG. 7) concerning the third mode that gives the top priority on the reduction of the total transmission cost will be described below. The cost reduction in comparison with the second mode is primarily achieved by substituting the transmissions to destinations, to which only facsimile is applicable, with transmissions to other destinations, for which the same facsimile numbers are registered.

The third mode processing is similar to that of the second mode processing shown in FIG. 25 except the third mode transmission list preparation processing (step S333) as shown in FIG. 31. Furthermore, the third mode transmission list preparation processing consists of the cost top-priority processing 1 through 3 as shown in FIG. 32, wherein the cost top-priority processing 1 and 2 are similar to the cost priority processing 1 and 2 of the second mode processing. Therefore, the cost top-priority processing 3 in the step S343 will be described below referring to FIG. 33A and FIG. 33B.

First, the control unit 11 makes a judgment as to whether any group exists in the FAX-only list (step S351).

If it is judged that no group exists in the FAX-only list, the process terminates. If it is judged that one or more groups exist in the FAX-only list, the control unit 11 sets FAX as the transmission type for the transmission list (step S352), and sets “1” to the parameter M as the initial value (step S353).

The control unit 11 makes a judgment as to whether any destination with the same FAX number as the FAX number of the M-th group (target group) of the FAX-only list is included in the transmission list (step S354).

If it is judged that the destination exists, the control unit 11 registers an instruction for preparation of a request description to the notification method for the destination of the transmission list having the same FAX number as the FAX number of the target group (step S366), and deletes the target group from the FAX-only list (step S367). The process advances to the step S368.

The “instruction for preparation of a request description” means the processing of preparing a request description including the data of all destinations of the target group and a message requesting to distribute the transmitted file to all the destinations, i.e., to circulate the file, and adding the request description, for example, to the main body of an e-mail to be sent to the destinations having the same FAX number as the FAX number of the target group.

Thus, the users of the destinations having the same FAX number are assumed to be in the same physical location so that the transmitted file can be distributed among them, so that duplicating facsimile transmissions can be avoided.

If it is judged that no destination with the same Fax number exists, the control unit 11 detects a group in the FAX applicable list having the same FAX number as the FAX number of the target group (step S355), and transcribes the detected destination names to the target group (step S356).

Then, the control unit 11 makes a judgment as to whether the destination having the same name as the destination name of the target group exists in the transmission list (step S357). If it is judged that the same destination exists, the control unit 11 deletes the same destination from the transmission list (step S358). If it is determined that no such destination exist, the step S358 is skipped.

The FAX number that represents the target group, as well as all the transmission numbers and destination names of the target group are transcribed, to the transmission list (steps S359 through S361).

After that, the control unit 11 makes a judgment as to whether more than one destination exists in the target group (step S362). If it is judged that more than one destination exists, the control unit 11 registers an instruction for preparing a facsimile header page to the notification method in the transmission list column, on which the data of the target group are transcribed (step S363). If there is only one destination, the step S363 is skipped.

Then, the control unit 11 makes a judgment as to whether any e-mail notification setting exists concerning the destinations of the target group (step S364). If it is judged that an e-mail notification is set, the control unit 11 additionally transcribes the e-mail address of the destination to the notification method in the transmission list column, to which the data of the destination is transcribed (step S365). If it is judged that no e-mail notification is set, the step S365 is skipped.

Subsequently, the control unit 11 makes a judgment as to whether the processing for all the groups of the FAX-only list is finished (step S368). If it is judged that the processing is not finished, the control unit 11 adds “1” to the value of the parameter M (step S369), and returns to the step S354 to executed the processing for the remaining group.

Thus, in the cost top-priority processing 3, if other destinations exist having the FAX numbers same as the ones for the destinations, to which only facsimile is applicable, the circulation of files to the other destinations can be requested. Therefore, it is possible to avoid even the facsimile transmissions for destinations, to which only facsimile is applicable.

It is obvious that this invention is not limited to the particular embodiments shown and described above but may be variously changed and modified without departing from the technical concept of this invention.

Although the above description is made assuming that the data transmission apparatus is a facsimile apparatus, the invention is applicable to image scanners and copying machines having network capabilities as well. It is also applicable to a system incorporating an image scanner connecting with computers having network capabilities via interfaces such as SCSI (small computer system interface) and USB (universal serial bus).

The data transmission program can be provided as application software that causes computers to function as data transmission apparatuses, or provided as a built-in function of copying machines or image scanners.

The application software is provided stored in computer readable storage media, such as flexible disks and CD-ROMs. The application software can also be stored in a server, and be downloaded to computers to be installed via a computer network or a telephone network.

It is also possible to activate the application software stored in a server from the client side via a computer network to execute it directly.

The data contained in a transmitted file can be not only image data obtained by reading a document image but also image data generated by graphic software. Moreover, graphic data can be data inputted by external equipment via a network.

What is claimed is:

1. A data transmission apparatus comprising:
an address book means on which an e-mail address, a file transfer server address and a facsimile number can be registered as an address for a destination;
a setting means for setting one mode from a plurality of modes available for selecting an address applicable to a destination, when a plurality of destinations registered in said address book means are assigned as multicasting destinations;
a selection means for selecting an address suitable for each destination according to the set mode; and
a transmission means for executing multicasting transmission using a transmission protocol corresponding to the selected address for each destination.

2. A data transmission apparatus as claimed in claim 1, wherein said modes include a mode for reducing total transmission time.

3. A data transmission apparatus as claimed in claim 2, wherein said selection means reduces data transmission frequency, and thus total transmission time, by means of prioritizing an e-mail address when said mode for reducing total transmission time is set.

4. A data transmission apparatus as claimed in claim 3, wherein said selection means reduces total transmission time by means of prioritizing either a file transfer server address or a facsimile number, whichever giving a shorter transmission time, when both are applicable.

5. A data transmission apparatus as claimed in claim 1, wherein said modes include a mode for reducing total transmission cost.

6. A data transmission apparatus as claimed in claim 5, wherein said selection means reduces total transmission cost by means of prioritizing both an e-mail address and a file transfer server address when said mode for reducing total transmission cost is set.

7. A data transmission apparatus as claimed in claim 6, wherein said selection means reduces total transmission cost by means of substituting transmission to a destination for which only facsimile is applicable with transmission to another destination registered with a same facsimile number.

8. A data transmission method comprising the steps of:
setting one mode from a plurality of modes available for selecting an address applicable to a destination, which is registered on an address book means on which an e-mail address, a file transfer server address and a facsimile number can be registered as an address for the destination, when a plurality of the destinations are assigned as multicasting destinations;
selecting an address suitable for each destination according to the set mode; and
executing multicasting transmission using a transmission protocol corresponding to the selected address for each destination.

9. A data transmission method as claimed in claim 8, wherein said modes include a mode for reducing total transmission time.

10. A data transmission method as claimed in claim 9, wherein said step of selecting an address reduces data transmission frequency, and thus total transmission time, by means of prioritizing an e-mail address when said mode for reducing total transmission time is set.

11. A data transmission method as claimed in claim 10, wherein said step of selecting an address reduces total transmission time by means of prioritizing either a file transfer server address or a facsimile number, whichever giving a shorter transmission time, when both are applicable.

12. A data transmission method as claimed in claim 8, wherein said modes include a mode for reducing total transmission cost.

13. A data transmission method as claimed in claim 12, wherein said step of selecting an address reduces total transmission cost by means of prioritizing both an e-mail address and file transfer server address when said mode for reducing total transmission cost is set.

14. A data transmission method as claimed in claim 13, wherein said step of selecting an address reduces total transmission cost by means of substituting transmission to a destination for which only facsimile is applicable with transmission to another destination registered with a same facsimile number.

15. A data transmission program for causing a computer to execute process of the steps of:
setting one mode from a plurality of modes available for selecting an address applicable to a destination, which is registered on an address book means on which an e-mail address, a file transfer server address and a facsimile number can be registered as an address for the destination, when a plurality of the destinations are assigned as multicasting destinations;
selecting an address suitable for each destination according to the set mode; and
executing multicasting transmission using a transmission protocol corresponding to the selected address for each destination.

16. A data transmission program as claimed in claim 15, wherein said modes include a mode for reducing total transmission time.

17. A data transmission program as claimed in claim 16, wherein said step of selecting an address reduces data transmission frequency, and thus total transmission time, by means of prioritizing an e-mail address when said mode for reducing total transmission time is set.

18. A data transmission program as claimed in claim 17, wherein said step of selecting an address reduces total transmission time by means of prioritizing either a file transfer server address or a facsimile number, whichever giving a shorter transmission time, when both are applicable.

19. A data transmission program as claimed in claim 15, wherein said modes include a mode for reducing total transmission cost.

20. A data transmission program as claimed in claim 19, wherein said step of selecting an address reduces total transmission cost by means of prioritizing both an e-mail address and file transfer server address when said mode for reducing total transmission cost is set.

21. A data transmission program as claimed in claim 20, wherein said step of selecting an address reduces total transmission cost by means of substituting transmission to a destination for which only facsimile is applicable with transmission to another destination registered with a same facsimile number.

22. A computer readable storage medium stored with said data transmission program as claimed in claim 15.
